(19) United States
(12) Patent Application Publication
(10) Pub. No.: US 2008/0189194 A1
(43) Pub. Date: Aug. 7, 2008

(54) SYSTEMS AND METHODS FOR CUSTOMIZED FITTING, BUILDING AND SELLING OF FOOTWEAR, AND FOOTWEAR ASSEMBLIES FORMED FROM SUCH METHODS

(75) Inventor: Joseph Bentvelzen, Edgewood, WA (US)

Correspondence Address: PERKINS COIE LLP;PATENT-SEA, P.O. BOX 1247, SEATTLE, WA, 98111-1247, US

(73) Assignee: Vitality, Inc., Edgewood, WA (US)

(21) Appl. No.: 11/963,676

(22) Filed: Dec. 21, 2007

Related U.S. Application Data
(60) Provisional application No. 60/876,908, filed on Dec. 22, 2006.

(51) Int. Cl. G06F 17/30; G06Q 30/00; G06Q 90/00

(52) U.S. Cl. 705/27; 705/26

(57) ABSTRACT

Systems and methods for customized fitting, building and selling of footwear are disclosed herein. Additionally, footwear assemblies formed using such systems and methods are herein disclosed. Some embodiments of systems can substantially automate and increase accuracy of a customer-specific footwear custom-fitting process while decreasing cost and increasing the convenience of maintaining and tracking a retail footwear inventory. Systems and methods disclosed herein can be used by a provider of footwear (e.g., shoes, boots, sandals, slippers, etc.), such as a retailer or manufacturer, to produce and sell custom-fit, custom-built footwear for a customer. Moreover, the systems and methods can be used to select and build custom-fit footwear for each customer's foot at on on-site location (e.g., retail store, etc.) without the need for on-site complex shoe manufacturing equipment or the services of a professional shoe-maker.

### CROSS-REFERENCE TO RELATED APPLICATION(S)

The present application claims priority to U.S. Provisional Patent Application No. 60/876,908 filed on Dec. 22, 2006, entitled “METHOD OF RETAIL SELLING AND MANUFACTURING CUSTOM-FIT SHOES,” and incorporated herein in its entirety by reference.

### TECHNICAL FIELD

Systems and methods for customized fitting, building and selling of footwear are disclosed herein. Additionally, footwear assemblies formed from using such systems and methods are herein disclosed.

### BACKGROUND

Conventional footwear (i.e., shoes, boots, sandals, etc.) are typically manufactured, packaged, and sold as a set of left and right “shoes” for specified sizes. Pre-manufactured footwear sets are designed and built to accommodate an average size foot, although the size and shape of feet vary greatly from individual to individual. In addition, an individual's own two feet are often different sizes. Accordingly, an individual can have great difficulty finding footwear that fits comfortably for both feet.

When a customer visits a footwear retailer to buy a pair of shoes, the customer may first select a particular style and sub-style of shoe from the selection of shoes on display. While some customers are interested in footwear based on current fashion, other customers prioritize footwear selection based on comfort and function. Additionally, some footwear customers may be interested in footwear based on support and/or stance correction features. Footwear retailers often must carry hundreds of pairs of shoes in stock in order to provide a variety of styles, sub-styles and sizes to accommodate their diverse clientele. Because inventory storage and investment costs are limited resources, most footwear retailers carry large quantities of shoes in the most common sizes and small quantities of shoes in small or large sizes. Customers with small or large feet who prefer a large selection of shoes must find footwear retailers that carry larger inventories of small or large size shoes or they may need to place special orders for footwear and wait for shipment.

Some footwear retailers provide custom-made footwear designed to be worn specifically by the purchasing customer; however, these footwear products can be highly labor-intensive and costly to build. Additionally, the process of making custom-made footwear by conventional shoe-makers can often take a great deal of time after the customer places an order.

### BRIEF DESCRIPTION OF THE DRAWINGS

FIG. 1 is a schematic illustration of a system for building customized footwear in a retail outlet in accordance with an embodiment of the invention.

FIG. 2 is a schematic block diagram of aspects of a computer system that may employ aspects of the disclosure.

FIG. 3 is a schematic block diagram illustrating aspects of a simple, yet suitable system in which aspects of the disclosure may operate in a networked computer environment.

FIG. 4 is perspective view of a multi-component footwear assembly in accordance with an embodiment of the disclosure.

FIG. 5 is a perspective view of a variety of internal components that can be inserted into a shell and form the custom fit interior of the footwear assembly in accordance with an embodiment of the disclosure.

FIG. 6 illustrates cross-sectional views of varying footbeds in accordance with an embodiment of the disclosure.

FIG. 7 illustrates schematic cross-sectional views of footbeds having different medial or lateral support areas in accordance with an embodiment of the disclosure.

FIG. 8 illustrates schematic cross-sectional views of a plurality of heel counters for fitting feet with different heel widths in accordance with an embodiment of the disclosure.

FIG. 9A is a partially schematic top perspective view of selected internal components useable in the footwear, including a footbed and heel counter in accordance with an embodiment of the disclosure.

FIG. 9B illustrates the internal components from FIG. 9A positioned within another shell of the footwear in accordance with an embodiment of the disclosure.

FIGS. 10A-D illustrate a plurality of partially schematic top perspective views of a footwear assembly during a building process in accordance with another embodiment of the disclosure.

FIG. 11A illustrates a plurality of filler pads configured to fit in a heel region of a shell to help define a heel pocket for the foot in accordance with an embodiment of the disclosure.

FIG. 11B is a partially schematic side view of a shell illustrating the relative locations of selected internal components in accordance with an embodiment of the disclosure.

FIG. 11C is a schematic cross-sectional, rear view of the shell take along line C-C shown in FIG. 11B.

FIG. 12 is a perspective view of a heel wrap in accordance with an embodiment of the disclosure.

FIG. 13 is a perspective view of a heel wrap in accordance with another embodiment of the disclosure.

FIG. 14 is a partially-exploded side perspective view of an embodiment of footwear assembly having side filler pads in accordance with an embodiment of the disclosure.

FIG. 15 is a partially cut-away, exploded side perspective view of a footwear assembly having another side filler pad in accordance with another embodiment.

FIGS. 16-18 are partially-exploded side perspective views of footwear assemblies with forefoot wraps in accordance with additional embodiments of the disclosure.

FIG. 19 is a flow diagram of a method for selling custom-fit footwear assemblies by a retailer in accordance with an embodiment of the disclosure.

FIG. 20 is a schematic block diagram illustrating aspects of a system for customized fitting, building and selling of footwear in accordance with another embodiment of the disclosure.

FIG. 21 is a flow diagram of a routine for customized fitting, building and selling of footwear assemblies in accordance with an embodiment of the disclosure.

### DETAILED DESCRIPTION

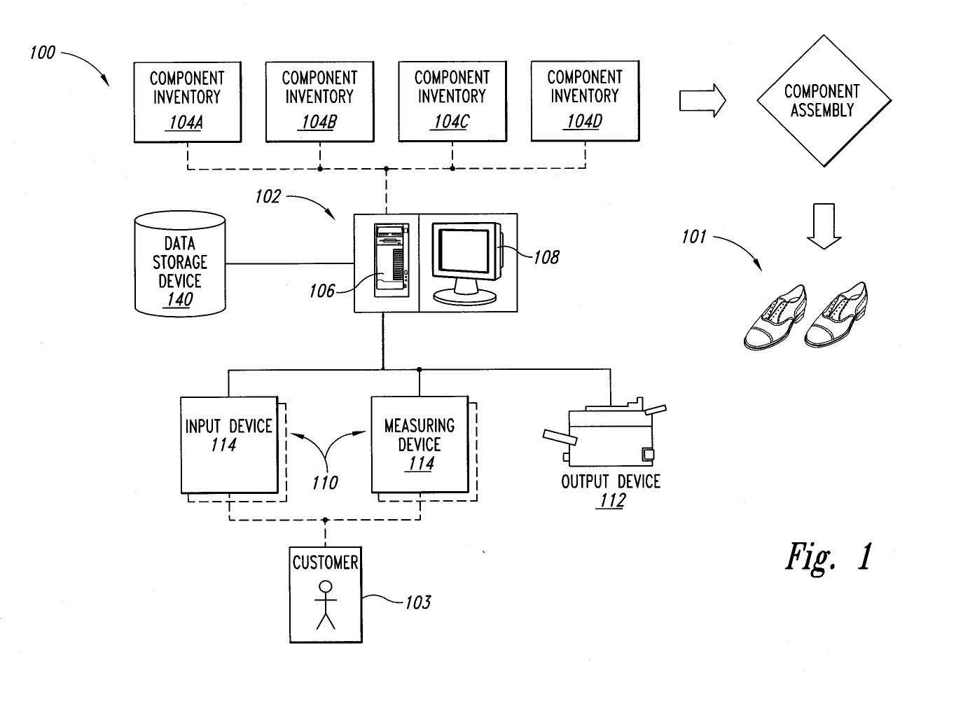

Various embodiments of the present disclosure are directed to systems and methods for customized fitting, building and selling of footwear. Some embodiments of the present disclosure include computer-implemented methods and systems for receiving customer-specific information, assembling customer-specific foot profiles, and/or proposing footwear assembly components for building multi-component footwear assemblies. Other embodiments of the present disclosure need not include computer-implemented methods and systems for customized fitting, building and selling of footwear. In at least one embodiment of the present disclosure, a person wishing to purchase footwear, e.g., shoes, boots, sandals, slippers, etc., can be custom-fitted and have the footwear built at a retail outlet. The customer can choose from a variety of fashionable and functional footwear styles that can be built using components from on site inventories. A suitable computing device, such as a networked computing device, an in-store computing device, etc., can be used for establishing one or more customer-specific foot profiles. Once generated, the customer-specific foot profiles can be used to select, build and sell custom-fit footwear from the retail outlet. These and other features of various embodiments of the disclosure are explained in greater detail below and in related FIGS. 1-21.

The following description provides specific details for a thorough understanding and enabling description of these embodiments. One skilled in the art will understand, however, that the disclosure may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the disclosure. Certain terms may even be emphasized below; however, any terminology intended to be interpreted in any restricted manner will be overtly and specifically defined as such in this Detailed Description section.

FIG. 1 depicts a system 100 for customized fitting, building and selling of footwear 101 in accordance with an embodiment of the disclosure. Use of the system 100 by the retailer can substantially streamline and increase accuracy of a customer-specific footwear custom-fitting process at the retail outlet while decreasing cost, decreasing inventory, and increasing the convenience of maintaining and tracking a retail footwear inventory. The system 100 can be used by a retailer or other provider of footwear (e.g., shoes, boots, sandals, slippers, etc.) to produce and sell custom-fit, custom-built footwear 101 for a customer 103. Moreover, the system 100 can be used to select and build custom-fit footwear for each customer's foot at an on-site location (e.g., retail store, etc.) without the need for on-site complex shoe manufacturing equipment or the services of a professional shoe-maker.

In one embodiment, the retailer (or other provider) of footwear uses the system 100 at an on-site store or other facility suitable for assisting customers 103 with footwear fitting and purchase options. Briefly, the system 100 is configured to collect information from the customer 103, to determine the proper combination of footwear components 104A-104D needed to build the footwear 101 that best fits the customer's feet, and to provide the various footwear components that can be assembled at the retail location to form the final customized footwear for the customer. The system 100 can also be used to generate customer-specific footwear profiles and footwear assembly options that can be used later to construct other footwear for that same customer in an even faster and more efficient manner.

The system 100 can include a computer system 102 with a central processing unit 106, a display monitor 108 and a data storage device 140. The computer system includes a program that uses the information from or about the customer 103 (discussed in greater detail below) and calculates which components are needed to custom build the footwear for each of the customer's feet. The computer system 102 can be connected to an inventory system 104 that includes separate collections of a plurality of footwear components 104A-104D, such as outer shells, footbeds, heel counters, filler pads, etc., that can be mixed and matched to custom build footwear for the specific customer 103. Accordingly, footwear components from the inventory 104 can be assembled in a plurality of different combinations to form one or more footwear assemblies (described in more detail below).

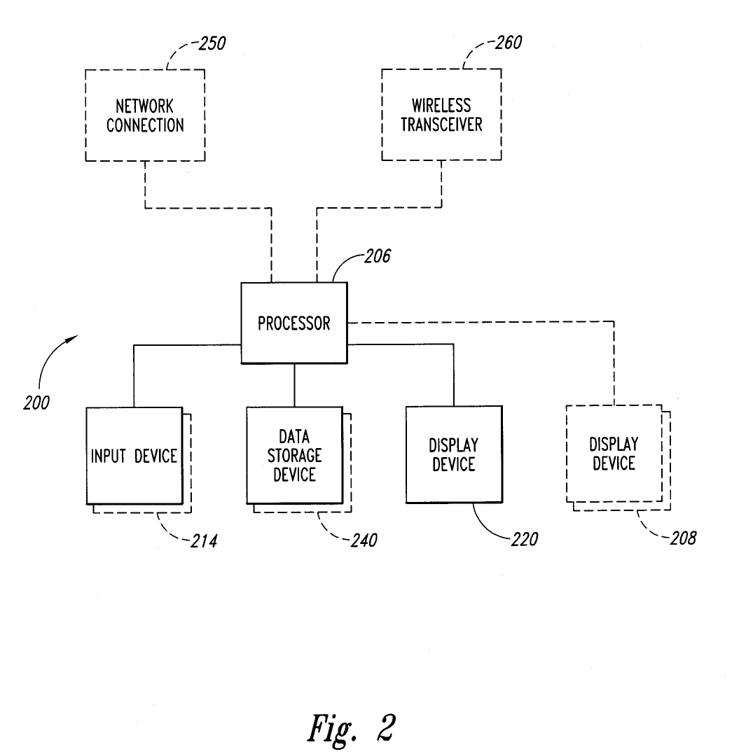

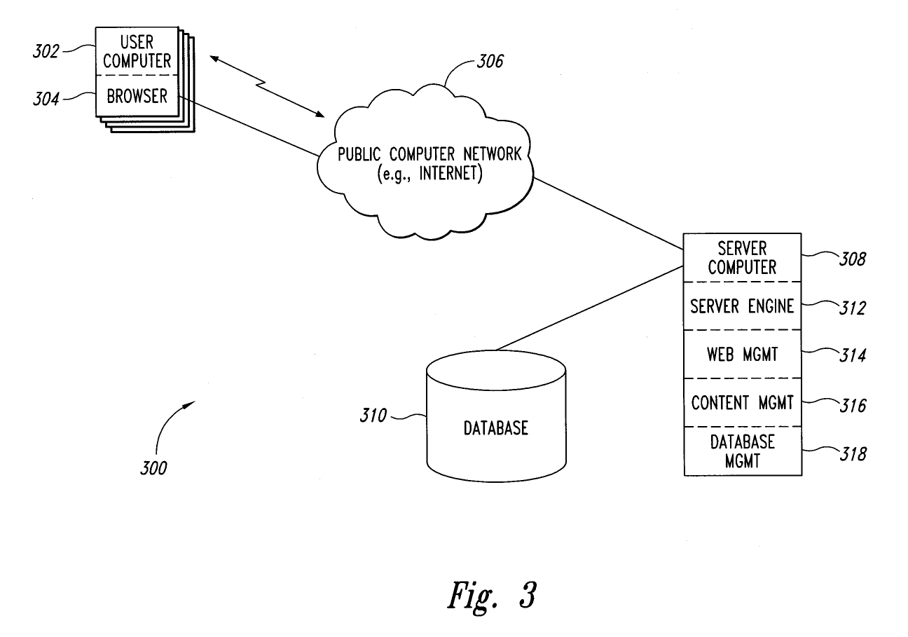

The computer system 102 of the illustrated embodiment is configured to assist a user (e.g., a customer, a retail clerk, shoe salesman, technician, etc.) in collecting customer-specific foot and footwear information, so as to generate a footwear profile specific for that customer 103. For example, the computer system 102 can include a client computer, such as a workstation, desktop, laptop, hand-held unit, etc., coupled to one or more input devices 110 and output devices 112 to assist the user in collecting and using customer-specific footwear information to quickly custom build the footwear assemblies while the customer waits at the retail outlet. Details of suitable computer systems are shown schematically in FIGS. 2 and 3, and are discussed in greater detail below after the discussion of the footwear components used in selected embodiments of the present disclosure.

In one embodiment, the system 100 is configured so that the user can gather information from the customer 103 about, as an example, the desired outer shell-style, any special footwear needs or other relevant personal information about the customer. This customer information is input into the computer system 102 via the input device 110. In one embodiment, the system is configured to collect additional customer data by prompting the customer 103 (or other user of the computer) to answer selected questions in a questionnaire format or other format. Additionally, the questionnaire may be administered on paper, via a computer display screen 108, orally, remotely via a web-site, etc.

The system 100 also includes one or more computer-operated measuring devices 114 that measure each of the customer's feet and deliver data to the computer's central processing unit 106. One or more measuring devices 114 can be used to collect three-dimensional anatomical data and other information about the customer's feet in static and/or dynamic conditions. The measuring devices 114 can collect different types of measurement data that may include the overall size and width of the foot, the width and height of the heel, the size and shape of the longitudinal and transverse arches, the size and width of the forefoot, angular orientation (i.e., the amount of supination or pronation), the size and locations of any bunions and calluses, biomechanical abnormalities, pressure points, etc. Moreover, in some embodiments, the measuring devices 114 may obtain three-dimensional measurements of each foot while the customer is standing or sitting (static measurements), and in other embodiments, while the customer 103 is walking, running, or performing other forms of movement (dynamic measurements). For example, in one embodiment, the measuring device 114 may include a three-dimensional (3-D) imaging device, such as a laser and/or light scanners capable of scanning and delivering data to the central processing unit 106 for producing high resolution 3-D images of the entire foot below the ankle, below the calf muscle, or from another selected position below the knee.

Each customer will have a unique weight and pressure point distribution for each foot when standing or when actively moving. Depending on the type and level of intensity of the activity, the weight distribution for each foot at each pressure point can change dramatically when in motion. Accordingly, in some embodiments, the measuring devices 114 can include pressure sensors for detecting and calculating a customer's weight distribution on their feet when static and/or when in dynamic movement. One of ordinary skill in the art will recognize a variety of computer-operated measuring devices 114 and/or imaging devices available which may be used to extract data for generating the customer-specific footwear profile and footwear assembly options.

After the measuring devices 114 deliver the measurement data to the processor 106, the processor may run one or more routines for processing and/or displaying the data (described further below). The routines may also use the customer information collected from the questionnaire relating to, as an example, the customer's gender, age, activity level, and/or special footwear needs. The routine also uses data collected from the questionnaire or other sources relating to the customer's preference information about a category of footwear (e.g., dress, casual, lifestyle, athletic, etc.), footwear styles within a category (e.g., heels, flats, loafers, etc.), and colors and/or materials (e.g., black, brown, leather, suede, water-proof, etc.). For example, the customer may wish to purchase athletic shoes and indicate that she regularly walks trails on uneven ground. This information can be incorporated into the footwear profile for properly selecting footwear assembly components that provide additional foot stability for walking on trails. The routine may also use information related to the customer's health concerns that could influence or affect the comfort-level and functionality of the footwear. For example, the routine could take into consideration customer information related to a specific orthopedic prescription, arthritis of the feet, diabetes, broken or previously broken bones in the foot, sore or tender areas on the foot, etc.

The processor 106 can use the measurement data and/or image data, as well as the customer-specific information to generate the customer-specific footwear profile. The footwear profile can include measurement data for each individual foot, such that footwear selection options may differ between left and right feet so as to impact the subsequent footwear assembly process.

The footwear profile is used to determine which components from the various inventories 104A-104D should be used to build the footwear that best fits the shape, size and needs of the customer. The system 100 also allows the entire component inventory and associated selection options to be carefully controlled at the retail outlet for providing the maximum number of selection options while using a minimum amount of inventory so as to most closely anticipate the needs of the customers. In one embodiment, the on-site inventory for each internal component can be minimized, because inventory management can be carefully controlled, so that selected components can be re-ordered on an as-needed basis. Most components in the inventory are internal components of the footwear, so they are substantially unaffected by style or fashion changes. Accordingly, seasonal or other inventory turn-over of unused components is minimized or eliminated for most of the components (except for the outer shells), thereby helping to keep the overhead costs down, which helps keep the footwear cost lower without sacrificing quality.

The customer's selection process for the customized footwear can include as a first step, a customer's selection of an outer footwear shell, which dictates the overall external type and appearance of the resulting footwear assembly. In subsequent selection steps, the system 100 uses the shell information and the footwear profile information and selects from the inventory 104 the desired internal components for the footwear assembly to provide the customer with a customized fit. For example, the system can be configured to automatically eliminate or add components 104 for the footwear assembly to achieve the customer's needs and comfort levels communicated by the customer 103. After the system 100 has selected and identified the appropriate components for the selected footwear assembly, identified internal components are removed from the component inventory 104B-104D. The footwear shell and internal components can then be temporarily assembled for a trial fitting by the customer in real time at the retail location. If fit adjustments are needed to achieve the desired level of comfort and/or support for the customer, different components may be interchanged to achieve the correct fit. After the proper fit is achieved, the components 104 of the footwear assembly can be securely and finally assembled and provided to the customer for sale and immediate use. The system is also configured to retain customer information and footwear profiles with information about the individual components 104 assembled into the final footwear assembly for future reference.

In another embodiment, the customer-specific footwear profile is used to assist the customer in initially selecting the outer footwear shell. For example, the footwear profile can be generated, in part, by a customer's footwear preference information (e.g., category, style, gender, activity level, color, material, etc.). Based on this information, the system can provide a recommended set of outer shells that may meet the customer's needed. The system's subsequent selection steps of desired or appropriate internal components can occur as described above.

In one embodiment, the customer-specific footwear profile can be transmitted to a variety of output devices 112 at the retail location or at a remote location. As an example, the footwear profile information can be simultaneously provided to a plurality of computer display screens 108 or printers 112 so that a retail clerk, technician, cashier, shoe salesman, and/or stockroom attendant, can use the information. Accordingly, multiple people can use the customer profile information to provide real time customer service, and to efficiently operate the retail business. As an example, a technician can use the information from a customer's profile to assist the customer, while a stock room attendant can simultaneously use the same information to locate the recommended footwear components based on the customer's footwear profile to be provided to the technician for subsequent assembly of the footwear.

It is also anticipated that the system 100 in some embodiments may not include the computer system 102 for generating customer-specific footwear profiles and footwear assembly options. Instead, the system 100 may include some manual measuring devices, and manual information-collecting tools to compile the requisite information for the customer's profile. The retailer using the system 100 can manually generate customer-specific footwear information, and the footwear assembly options can be tailored to the footwear profile, as an example, based on a standardized or pre-established chart.

In the illustrated embodiment, the system 100 includes a plurality of component inventories 104A-104D containing components designed and fabricated to be assembled on-site at a retail location to build a final customized shoe consistent with the customer's footwear profile. The assembly components may be mixed and matched into a plurality of footwear assemblies, providing a diverse and extensive variety of footwear options without the need to manage an extensive quantity of items. The inventory 104 can include any number of footwear assembly components to the extent the retailer is satisfied with their ability to provide the functional and fashionable options most desirable by their specific clientele. The specific footwear components are described in detail below with respect to the building of footwear assemblies.

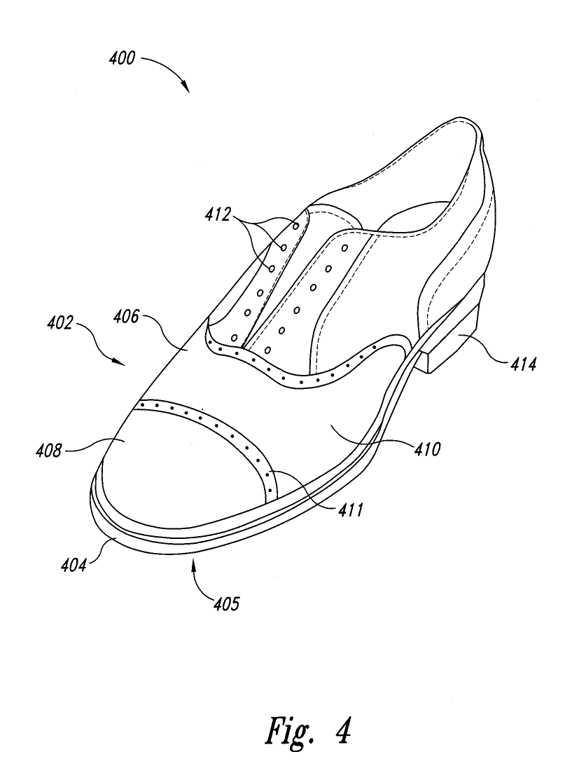

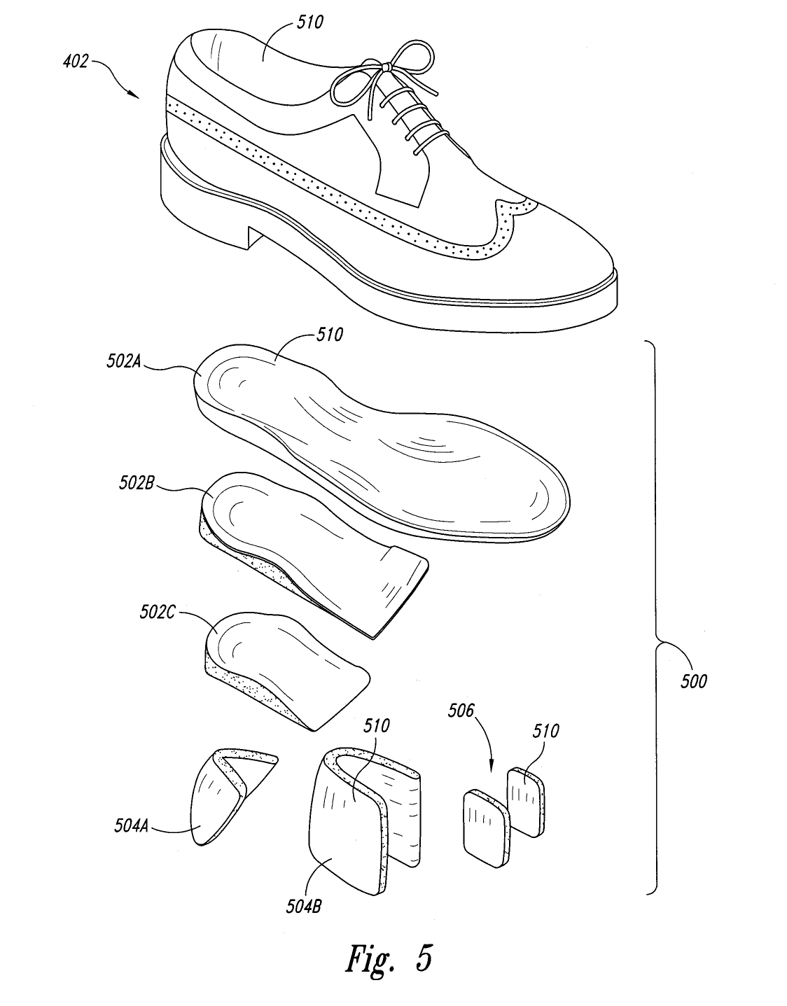

FIG. 4 is perspective view of a multi-component footwear assembly 400 constructed in accordance with an embodiment of the disclosure. The footwear assembly 400 includes a shell 402 and a plurality of internal components 500 (FIG. 5) within the shell 402 that form a custom-fit for the customer's foot. The shell includes an outer sole 404 and an upper portion 406. The outer sole 404 can be formed of durable material such as rubber, leather, plastic, other synthetic polymers, etc. In some embodiments, the outer sole 404 can also have tread (not shown) formed on a bottom surface 405 to provide better traction while wearing the assembly 400. The upper portion 406 of the footwear assembly 400 is fixed to the outer sole 402 and is formed to create the fashionable appearance of the footwear assembly 400. The upper portion 406 is also formed in a manner to securely retain the interior components and the customer's foot therein. For purposes of discussion, the shell 402 of the assembly 400 shown in FIG. 4 is formed in the appearance of a man's dress shoe, although the shell can have other styles for men, women, or children.

The shell 402 may include decorative or other distinctive features that enhance and/or determine the external appearance of the footwear assembly 400. For example, and as depicted in FIG. 4, the upper portion 406 of the footwear assembly 400 can include a tip 408, a quarter 410, and depending on the style of footwear assembly 400, the upper portion 406 may include stitches 411, welding, eyelets 412, laces (not shown), etc. In other embodiments not shown, distinctive features can include a shoe tongue, straps, buckles, snaps, zippers, corresponding hook and loop strips, etc. The shell 402 can also include a raised heel portion 414. In some embodiments of women's footwear, the shell 402 may include high heel portions 414.

As one of ordinary skill in the art will recognize, the upper portion 406 may be made of any material suitable for footwear. For example, the upper portion may be made of leather, suede, synthetic materials, as well as non-synthetic materials, breathable material, waterproof material, plastics, etc. Additionally, the outer layer 416 of the upper portion 406 can include one or more of a variety of colors and textures, such that the appearance and texture of a variety of footwear options available as conventionally made footwear, can be provided by the shell 402 of the footwear assembly 400.

After the shell 402 is selected for building the desired footwear assembly 400, internal components can be selected from the inventory 104A-104D (FIG. 1) for inserting into the shell 402 so as to custom-build the footwear assembly to the specific measurements and needs of a customer's foot. FIG. 5 is a perspective view of a variety of internal components 500 that can be inserted into the shell 402 to form the custom-fit interior of the footwear assembly 400. In some embodiments, the internal components 500 that are suitable for insertion into one type or style of a shell 402 may also be used in additional shells that the customer desires and/or is considering for purchase. In other embodiments, the internal components 500 that are suitable for insertion into one type of shell 402 may not be suitable for another type of shell. Accordingly, the selection of the shell 402 may further dictate which specific internal components 500 options are available to custom-fit the customer's foot with the selected shell 402.

The internal components 500 can include an insertable footbed 502 (i.e., an insole) and an insertable heel counter 504. In some embodiments, the smallest shell 402 that fits the customer's foot may be initially selected as a starting point when building the footwear assembly 400. Depending on the footwear profile information and the types of internal components 500 (e.g., footbeds 502, heel counters 504, etc.) needed and/or available to use with the selected style and size of shell 402, a larger shell 402 may be used. When a larger shell 402 is required and/or desired, or whenever excessive spaces are created between the foot and the shell 402, optional internal components 500, such as one or more insertable filler pads 506 may be used to prevent foot slippage within the shell and to provide additional support and comfort.

The footbed 502 forms the interior lining upon which the customer's foot rests. Examples of some optional footbeds 502A-C that may be used within a shell are shown in FIG. 5. Footbeds 502 can have variable overall lengths, different longitudinally and transverse arch supports, variable heel support shapes, different forefoot dimensions, different wedge (e.g., height) profiles, variation in density of material, etc. In some embodiments, the footbeds 502 can be trimmed and/or cut during the fitting/building process to accommodate a customer's foot and footwear assembly style.

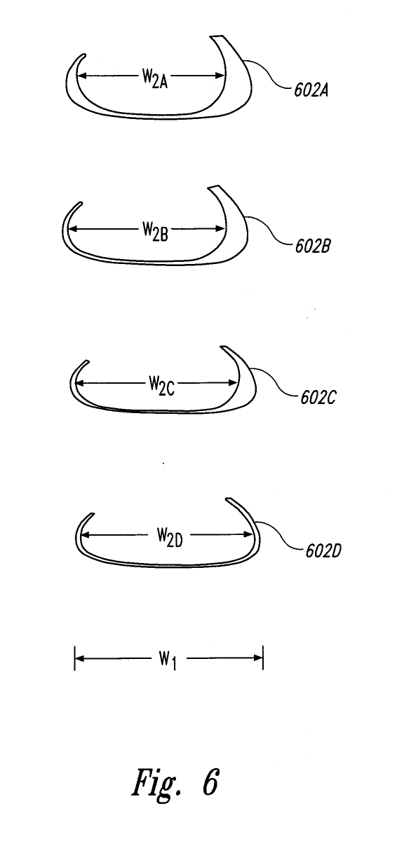

In one embodiment, the footwear assembly 400 can be custom-fit to a customer's foot width with an appropriate selection of a footbed 502 from the footbed inventory. The footbed 502 can have a shape with side edges that curve to fit the sides of a foot. For example, FIG. 6 illustrates cross-sectional views of four different footbeds 602A-D having curved side edges with the same exterior width W₁, thereby enabling them to be used in the same shell 402, but having different internal widths W_{2A-D} for supporting variable foot widths.

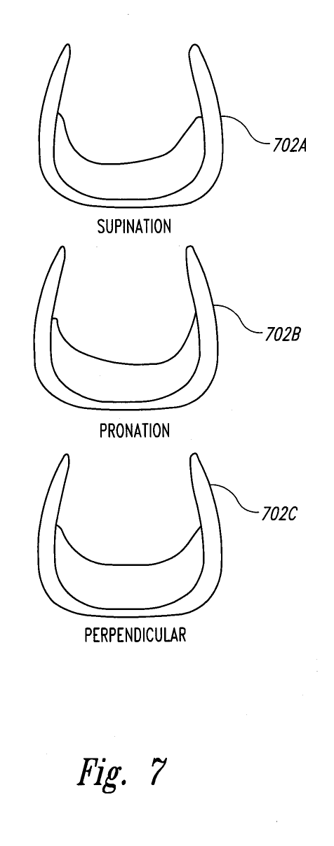

In another embodiment, the medial or lateral areas of the footbed 502 may be built up or sloped to control supination or pronation or neutral (perpendicular) orientation of the foot. FIG. 7 illustrates cross-sectional views of three footbeds 702A-C having different medial or lateral support areas used to control supination, pronation, and perpendicular foot positions. Selection of a footbed 502, may include selection of a footbed 702A-C based on the foot measurement data obtained by the one or more computer-operated measurement devices 114 discussed above, or based in part on information provided by the customer or his or her medical professional.

Referring back to FIG. 5, one or more heel counters 504, such as heel counters 504A and 504B can be suitable to insert into the shell 402. Accordingly, and like the selection parameters for the footbed 502, selection options for a heel counter 504 can be narrowed from a greater number of options available from the inventory 104 depending on 1) the selection of shell 402, and 2) the customer-specific footwear profile. In some instances, the footwear profile will restrict the number of shells 402 available to choose from based on the style of heel counter 504 desired for medical and/or other biomechanical needs of the customer. The heel counter 504 can be formed in a variety of sizes and shapes to accommodate differing shell styles and customer heel shapes. For example, the size of a heel counter 504 may vary in overall height as well as width. The contour of the heel counter 504 can also vary to accommodate wide, narrow or average-shaped heels while maintaining a common exterior dimension. Additionally, some embodiments of heel counters 504 may be adjustable to accommodate alternate shapes of the foot at the Achilles' tendon region.

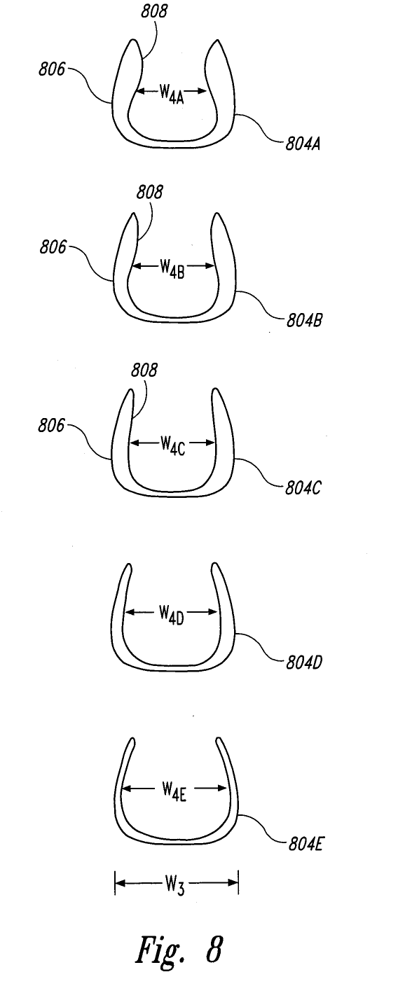

FIG. 8 illustrates cross-sectional views of a plurality of heel counters 804A-E for fitting feet with different heel widths in accordance with an embodiment. The heel counters 804A-E each have the same exterior width W₃, thereby enabling them to be used in the same shell 402, but each have different internal widths W_{4A-E} for supporting variable heel widths. In some embodiments, heel counters 504 can include an outer support layer 806 with an inner soft layer 808 attached to the support layer 806 and made from a forgiving material, such as foam. In one embodiment, the internal width W_{4A-E} can be adjusted by the thickness of either the soft layer 808, the support layer or both. For example a narrow heel counter, such as heel counter 804A may include a soft layer 808 located at its midline axis which receives the heel near the lower portion of the Achilles tendon region. The heel counter 804B has a slightly thinner soft layer 808 than the heel counter 804A and is designed to snugly receive and support a slightly thicker heel.

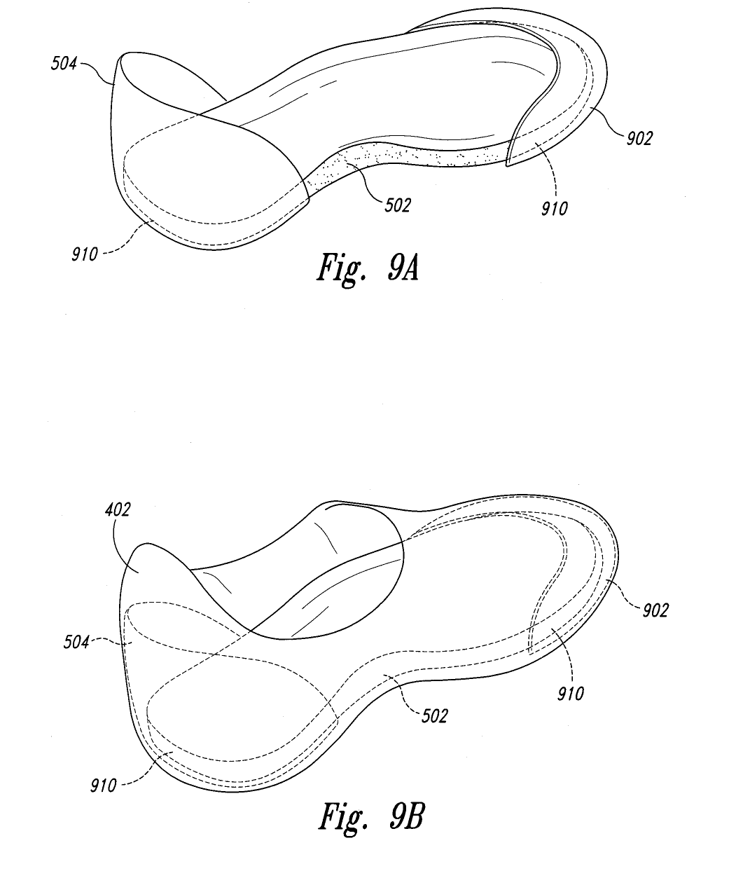

In one embodiment, the heel counter 504 is configured to securely connect to the footbed 502 before inserting these internal components 500 into the shell 402. The heel counter 504 can attach to the heel area of the footbed via a mechanical interconnection (e.g., pins and holes, tabs and slots, friction fits, etc.), by adhesive on either the heel counter 504, the footbed 502, or both, or other interconnection means. In another embodiment, the internal components 500 may be inserted into the shell 402 one component at a time and secured in place. FIG. 9A is a partially schematic top perspective view of a footbed 502 with a heel counter 504 secured to the footbed's heel area, and a toe box pad 902 attached to the toe area of the footbed to provide protection and support in the toe portion of the shell. The toe box pad 902 can have different thickness and/or construction to best accommodate the toe area of the customer's foot.

The toe box pad 902 (when used), can also be selected and securely attached to the footbed 502 before the footbed is inserted into the shell 402. FIG. 9B illustrates the internal components 500 from FIG. 9A inserted as a unit into the shell 402. In another embodiment, the heel counter 504 and/or the toe support pad 902 (when used) are inserted into the shell 402 first and positioned in the desired location. Each of the heel counter 504 and the toe box pad 902 have a bottom flange portion 910 that rests on the flat lower surface of the shell 402. The footbed 502 is configured to fit into the shell 402 and to set atop the flange portions 910 to securely hold the heel counter 504 and/or the toe support pad in place within the shell.

In some embodiments, the toe box pad 902 can be used to fill excess space in the toe box area of the shell 402. In many situations, some excess room around the toe area is preferred. Improved fit can be provided in the toe box area and in the forefoot area of the shell by using a thicker footbed or lifts under the footbed to raise the customer's foot within the shell 402. Accordingly, the system 100 can provide an inventory 104 of lift components configured to fit under or on top of the footbed 502. The lift components can also be configured to have other beneficial attributes, such as shock absorptive properties, foot alignment properties, insulative properties, anti-puncture properties, etc.

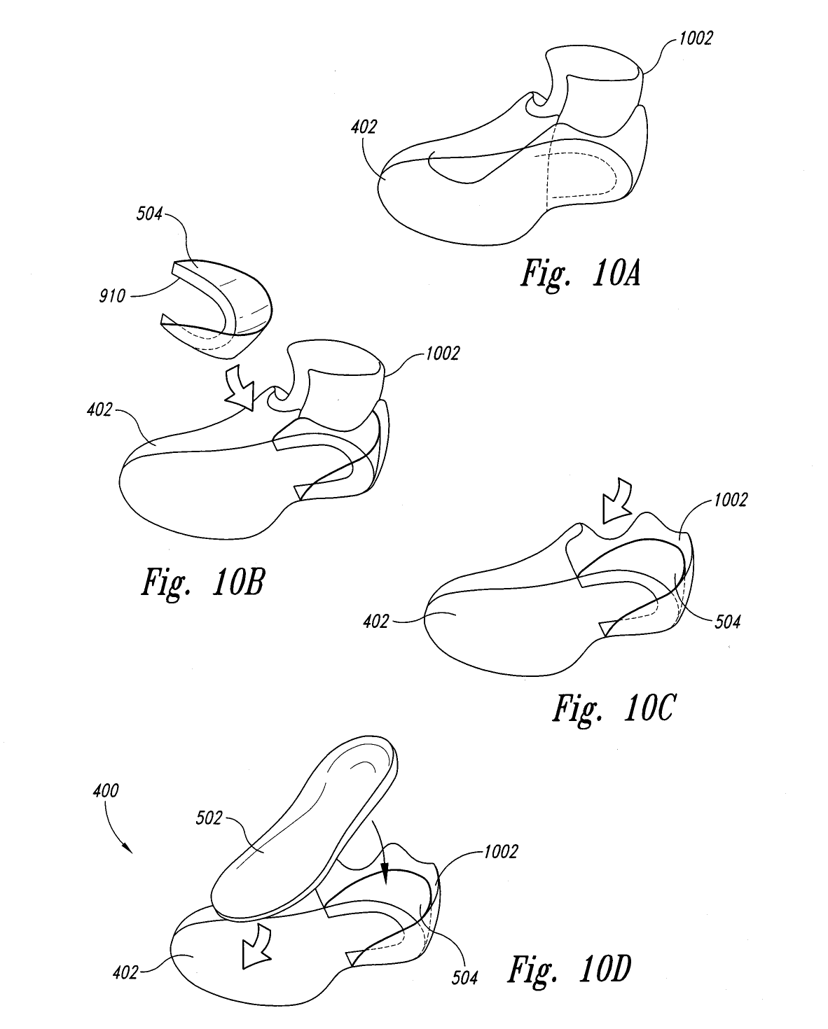

FIGS. 10A-D illustrate a plurality of partially schematic, top perspective views of a footwear assembly 400 during the building process in accordance with another embodiment of the disclosure. In one embodiment, the shell 402 can include a rear section of lining 1002 that is lifted and folded upward prior to insertion of internal components 500 (see FIG. 10A). In this embodiment, the heel counter 504 can be placed into the shell 402 (see FIG. 10B). In the step illustrated in FIG. 10C, the rear section of lining 1002 is folded downward to cover the heel counter 504. In the step illustrated in FIG. 10D, the footbed 502 is placed into the shell 402 and positioned to extend over the rear section of lining 1002 and the bottom flange 910 of the heel counter 504 to hold the heel counter 504 in place in the shell 402. When other internal components 500 are used, the components are positioned within the shell 402 in a selected order so the components can be properly positioned, oriented, and secured in place relative to the shell and the other components.

In one embodiment, all of the other internal components 500 are inserted into the shell 402 and the footbed 502 is inserted last to hold all of the components in place. Following the initial selection and positioning of the footbed 502, the heel counter 504, and any other internal component 500 into the shell 402, the customer can try on the assembled footwear to determine whether any changes are needed to properly fit the customer's foot. For example, the trial fitting process may be used to determine whether there are any excessive spaces or void areas between the foot and the shell 402, the footbed 502 or the heel counter 504.

When excessive void areas are detected and/or anticipated in the footwear profile, optional filler pads 506 or other internal components 500 may be used to prevent excessive foot slippage within the shell 402 and to provide additional support and comfort. For example, FIG. 11A illustrates a plurality of filler pads 506A-C configured to fit in the shell 402 in the heel region to accommodate a narrower foot. Specifically, the illustrated filler pads 506A-C are medial, rear, and lateral filler pads, respectively. Each filler pad 506A-C may include attachment regions 1102A-C, respectively, that can include hook and loop strips to be used for temporary attachment to corresponding loop and hook strips located on the inner region of the shell 402 and/or heel counter 504. In another embodiment, the attachment regions 1102A-C can include an adhesive or other secure interconnection to prevent undesirable movement and/or removal of filler pads 506A-C from the footwear assembly 400. FIGS. 11B and 11C show the relative locations of the footbed 502, the heel counter 504, medial filler pad 506A, lateral filler pad 506C, and rear filler pad 506B within the outer shell 402 of one embodiment. The footbed 502 and heel counter 504 can be secured in place within the outer shell 402 using the hook and loop fasteners, adhesive, friction fit, or other secure interconnections.

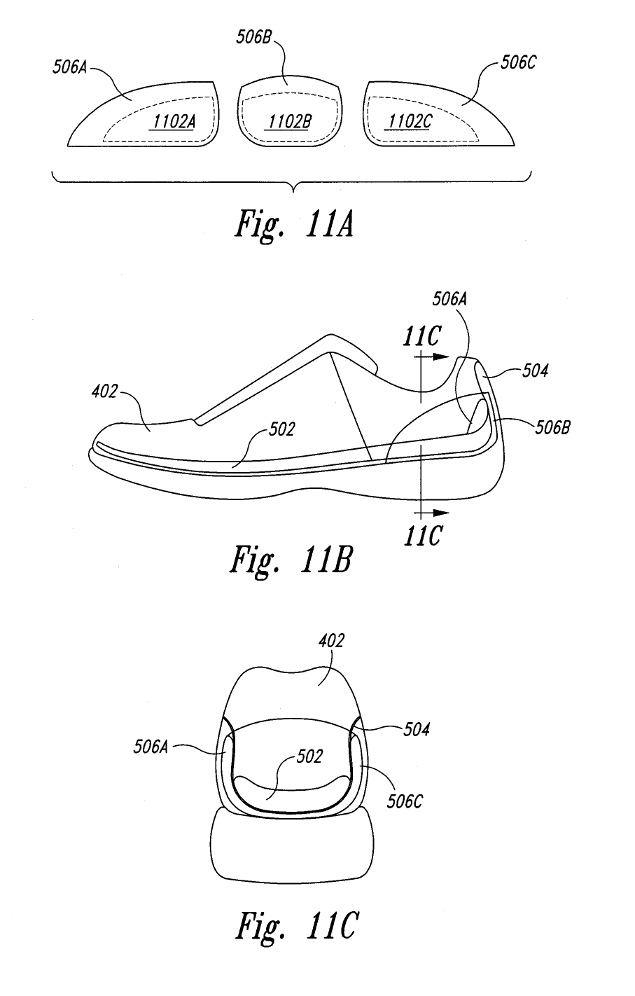

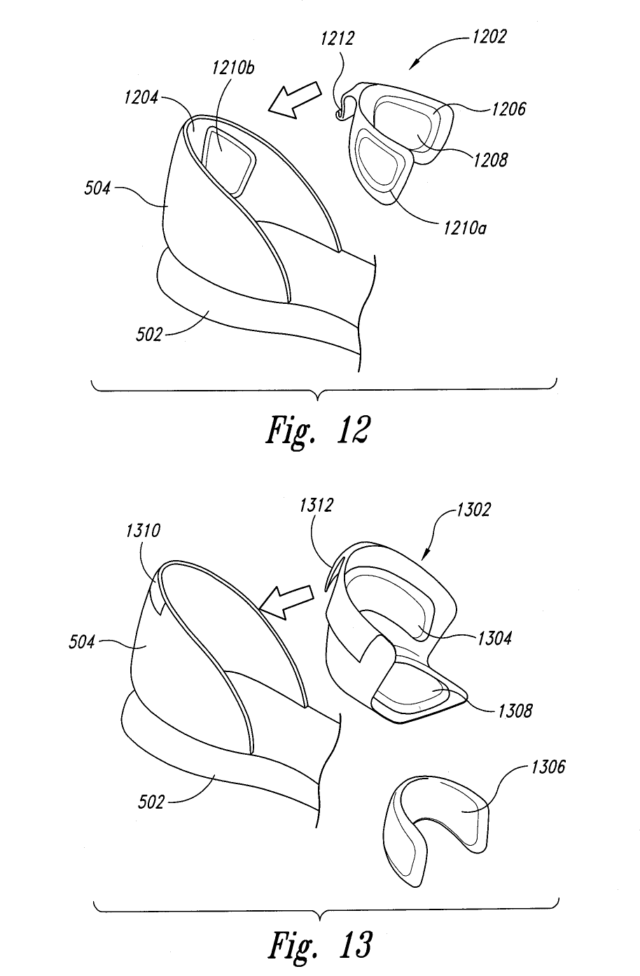

FIG. 12 is a partially exploded perspective view of a heel wrap 1202 configured to be received in or on the heel counter 504 to provide a finer adjustment to the custom-fit process. In the illustrated embodiment, the heel counter 504 is shown attached to the footbed 502 and removed from the shell 402. In this embodiment, the heel counter 504 can be a relatively stiff structure that forms a “heel cup.” This heel cup can be integrally connected to the heel area of the footbed 502, and in other embodiments, the heel cup can be a separate, removable component. The heel wrap 1202 is configured to attach to the heel counter 504. For example, the heel wrap 1202 can be positioned so it is between the customer's heel and the heel counter 504. In one embodiment, the heel wrap 1202 can be attached to the heel counter 504 prior to insertion into the shell 402. In another embodiment, the heel wrap 1202 may be attached to and/or removed from the heel counter 504, for example, during the trial fitting process. In another embodiment, the outer shell 402 can include an integral, relatively stiff heel cup structure, and the heel wrap 1202 can connect directly to the shell's heel cup to provide the proper fit for the customer's heel region.

The heel wrap 1202 of the illustrated embodiment is contoured to fit on the inside surface 1204 of the heel counter 504. The heel wrap 1202 can also include side pockets 1206 that can be filled with filler pads 1208. To removeably attach the heel wrap 1202 to the heel counter 504, corresponding hook and loop connector strips 1210a and 1210b or other attachment device can be adhered to the medial and lateral inside surfaces of the heel counter 504 and to the medial and lateral outside surfaces of the wrap 1202. Additionally, an optional rear flap member 1212 may be provided on the rear upper edge of the heel wrap 1202 that can extend over the rear outer surface of the heel counter 504 to help hold the heel wrap 1202 in position.

FIG. 13 is a top perspective view of another embodiment of a heel wrap 1302 with an accessible “U-shaped” side pocket 1304 formed on the medial, rear, and lateral sides of the heel wrap 1302 and configured to receive a corresponding “U-shaped” filler pad 1306. In another embodiment, and as illustrated in FIG. 13, the heel wrap 1302 can have a forward-extending lower flap 1308 configured to be positioned under the footbed 502 for securing the heel wrap 1302 in place. In some embodiments, additional corresponding hook and loop strips or other attachment device may be used to prevent displacement of the heel wrap 1302 while wearing the footwear assembly 400. For example, a modified heel counter 504 can have a hook or loop connector strip 1310 attached to a back upper edge that connects to a corresponding hook or loop connector strip attached a rear flap 1312 on the upper edge of the heel wrap 1302.

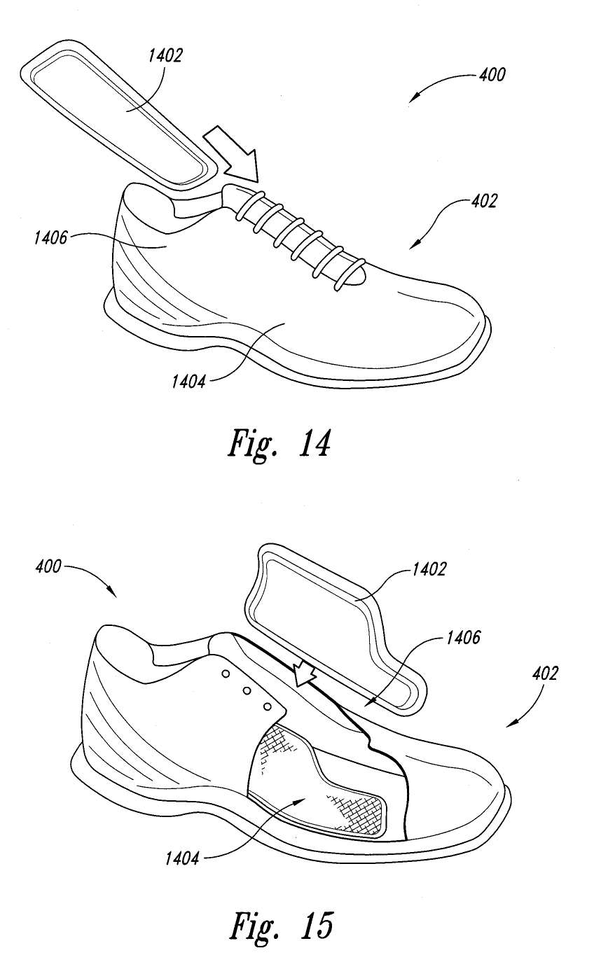

Additionally, filler pads 506 (shown in FIG. 5) can have different shapes and sizes to fill in different void areas located in various regions around the foot. The filler pads 506 can be releasable or permanently attached to the shell 402 by a plurality of mechanisms, such as corresponding hook and loop strips, adhesive, tape, or other secure interconnection mechanism. In another embodiment, side pockets (not shown) can be formed on the shell 402 that may be adapted to be selectively filled with filler pads 506. While filler pads 506 can be of any size and be provided in a plurality shapes (e.g., circular, oval, square, rectangular, etc.), larger side filler pads that can be positioned along the medial or lateral sides of the footwear assembly 400, can provide coverage and/or protection for large void areas around the customer's foot. In some embodiments, the sides of the shell 402 can be relatively thin with little or no side padding. For example, FIGS. 14 and 15 illustrate side perspective views of additional embodiments of footwear assemblies 400 with large side filler pads 1402 used to fill void areas 1404 between the shell 402 and the customer's foot. Additionally, and as shown in FIG. 14, large side pockets 1406 can be formed in the shell 402 that may be adapted to be selectively filled with the large side filler pads 1406. One of ordinary skill in the art will recognize, however, that the large side filler pads 1402 may also be attached by corresponding hook and loop strips, a suitable adhesive, or other suitable attachment device.

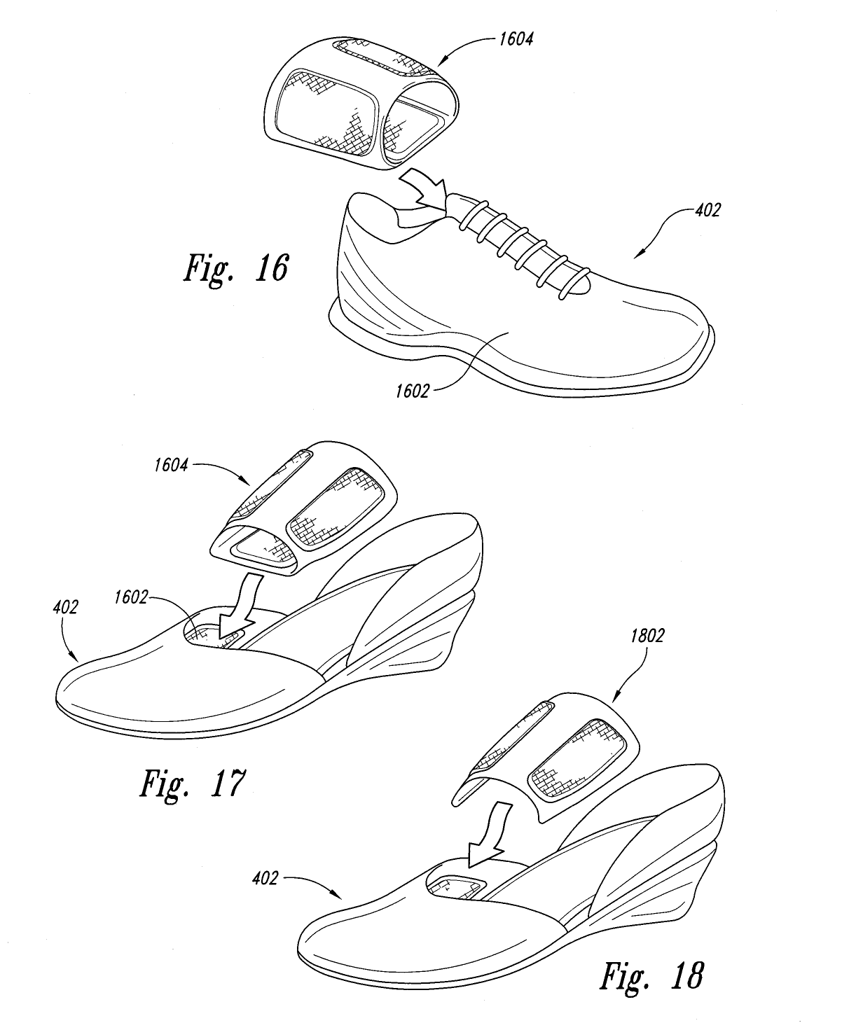

As shown in FIGS. 16 and 17, void areas 1602 created in the forefoot region can be filled by selecting and attaching a generally cylindrical-shaped forefoot wrap 1604 to the inner surface of the shell 402. In one embodiment, the forefoot wrap 1604 can be placed in the forefoot region of the shell 402 using an adhesive or corresponding hook and loop strips, for example. The forefoot wrap 1604 is securely attached to the inside surface of the shell 402 so the customer can easily insert and remove his or her foot without detaching the forefoot wrap 1604 from the shell. In another embodiment, shown in FIG. 18, an inverted, arched forefoot pad 1802 can be used to support and fit the upper forefoot surface of the foot.

During the trial fitting process, the customer can also identify any uncomfortable zones, such as transition zones between internal components 500. In one embodiment, the internal components 500 can be readjusted, trimmed, modified, etc. to eliminate uncomfortable transition zones during the fitting process. In another embodiment, however, the transition zones can be anticipated by the footwear profile and selection of components 500 can be pre-determined to place transitions in position with the parts of the customer's feet that would be the least sensitive to transition zones.

Upon final selection and approval of the footwear components and their positioning, the retailer, technician, and/or other footwear provider can finalize the assembly of the customized footwear assembly 400 to be purchased by the customer. In some embodiments, the multiple components can require adhesive to securely lock the components together. In some embodiments, the adhesive can be pre-applied to the components and require heat or pressure to activate the adhesive. In another embodiment, the adhesive may be applied by the technician/salesman at the time of assembly. In some embodiments, the components may be constructed of an anti-slip material and/or be of rigid construction, such that displacement or movement during wear is unlikely. In these embodiments, adhesive and/or other retention features, such as corresponding hook and loop strips, tape, staples, etc. may not be necessary or desirable.

In some aspects of the disclosure, the footwear assembly 400 can be repaired or refitted by removal and replacement of any worn components, thereby extending the useful life of the footwear. In addition, multi-component footwear assemblies 400 are comprised of individual components independently tracked and stocked in the inventory 400. The convenience and cost of replacement for one or more components is possible and can be significantly less costly than replacement of a pair of shoes. In other embodiments, certain internal components 500 may be temporarily removed from the footwear assembly 400, such as to be washed and/or adjusted before re-inserting the component back into position in the assembly.

The footwear assembly 400, once purchased, can also adapt to the changing needs of the customer. For example, if the customer is a child, the footwear assembly 400 can be constructed from a slightly bigger shell and utilize internal components 500 such as filler pads 506 to fill void areas until the child's foot grows. As the child grows, filler pads 506 can be removed and/or other internal components (e.g., heel counters 504, footbeds 502, etc. can be replaced to accommodate the larger feet and the changing footwear profile. Accordingly, the expense of having to regularly replace a pair of shoes or other footwear for children can be minimized by using the custom-fit footwear assemblies 400 disclosed herein.

In another example, customers experiencing changes in their feet for reasons other than growth (e.g., pregnancy, medical ailments, etc.) can benefit from the adaptability and flexibility of the footwear assemblies 400. For example, injury or pregnancy may make a foot swell. The swelling can cause discomfort when wearing footwear. Accordingly, when using the footwear assemblies 400 disclosed herein, the customer can simply remove selected internal components 500 and/or replace selected internal components to better accommodate the swollen condition. As the swelling reduces, selected internal components can be replaced.

Another aspect of the disclosure is directed to management of the inventory 104 of the various footwear components. In one embodiment, each shell 402 and internal component 500 can be marked with an identification indicia 510 for tracking and identification purposes (shown in FIG. 5). In one embodiment, the identification indicia can be a bar code or other computer-readable marking printed and/or displayed on the shells 402 and internal components 500. In one embodiment, the customer-specific footwear profile can narrow and propose component options by identifying shells 402 and the internal components 500 by their unique identifier 510. When a component is removed from, or added back into the inventory 104, the identifier indicia 510 can be used to track inventory quantities and for reordering additional stocks of individual components for the inventory.

A retailer, or other footwear provider, using the system 100, does not have to retain footwear on-hand in every style and size, which can be costly and require a large amount of storage space for the inventory 104. By using the system 100, the retailer can maintain a smaller inventory of components while still being able to custom-fit and build footwear assemblies 400 for their customers upon demand. By using multiple internal components 500 that can be assembled into a variety of shells 402, the retailer can reduce inventory 104, cost, and space necessary to provide fashionable and functional footwear options in multiple sizes for virtually all of its customers.

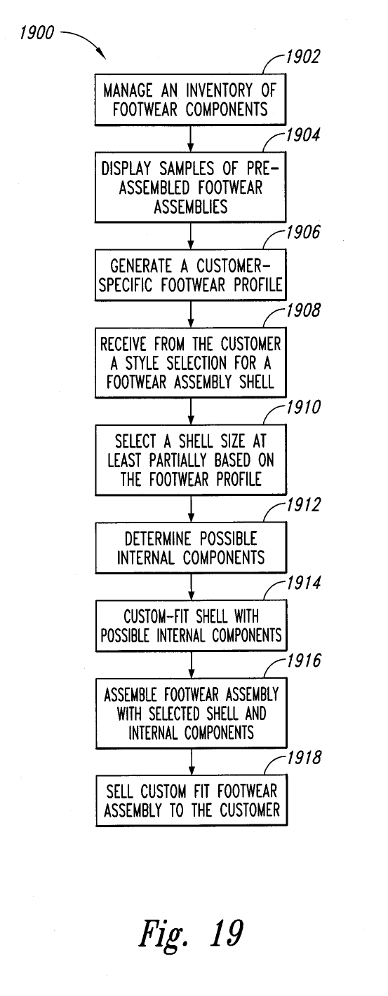

FIG. 19 is a flow diagram of a method 1900 for selling custom-fit footwear assemblies by a retailer in accordance with an embodiment of the disclosure. The method 1900 can include managing an inventory of footwear components (block 1902). The footwear components can include the necessary components to assemble a plurality of footwear assemblies in a variety of footwear styles. The method 1900 can also include displaying to a customer one or more samples of pre-assembled custom-fit footwear assemblies assembled from the footwear components (block 1904). The method 1900 can further include generating a customer-specific footwear profile (block 1906). The footwear profile can be generated using data collected using one or more measuring devices and from relevant information received from the customer. The method 1900 further includes receiving from the customer a style selection for a footwear assembly shell (block 1908). The method 1900 also includes selecting a shell size at least partially based on the footwear profile (block 1910).

Following selection of a shell size in block 1910, the method 1900 can include determining a set of internal components to accommodate the customer's feet at least partially based on the shell style, size, and the footwear profile (block 1912). The method 1900 can also include custom-fitting the shell with the set of selected internal components using a trial fitting process (block 1914). The trial fitting process can be used to at least partially determine the selected internal components to assemble in the footwear assembly. After determining the selected internal components, the method 1900 includes assembling the footwear assembly with the selected shell and internal components (block 1916). The method 1900 can further include selling the custom fit footwear assembly to the customer (block 1918). A footwear assembly may be assembled independently for each foot. The footwear profile may be retained by the retailer for further footwear assembly purchases by the customer.

The following is an example illustrating an embodiment of a method for using the system 100. A woman whose feet have been deformed by bunions wants to purchase a pair of pumps from a local footwear retailer. Because the bunions on her feet vary in size and location, the woman has, in the past, had difficulty finding footwear that comfortably fits both feet. She decides to purchase custom footwear from a local footwear retailer who uses the above-described method of selling and building custom-fit footwear assemblies (i.e. shoes).

The woman visits a retail store that displays various samples of completed custom shoes made by the method. The woman selects a desired style of pumps from the shoes on display. Next, the system's measurement device(s) are used to take separate 3-D measurements of each of the woman's feet, as discussed above. The woman also answers a questionnaire (provided orally or in writing) that includes several questions regarding her footwear preferences, activities, special needs, etc. The questionnaire can be provided before or after her feet are measured.

After the customer information is gathered and/or input into the computer system, the system generates a customer-specific footwear profile for each of the woman's feet. The footwear profile can include a set of narrowed selection options available to the salesman or technician for accommodating the woman's footwear needs and preferences. The system then uses the customer's footwear profile and information about the desired shell to identify the specific shell size and all of the internal components expected to be needed to custom-build the pumps to fit each of the woman's feet. The salesman then selects from the inventory the identified shells for the particular style of pump for each foot. The salesman also retrieves from the inventory the selected footbeds compatible with the shells, the identified heel counters compatible with the footbeds and the shells, and any other identified components identified by the system based upon the woman's footwear profile. If the customer's foot requires special corrective support for bunions, calluses or pronation problems, the system takes these factors into consideration when selecting the internal components. The selected internal components are then inserted and/or attached to the shell to provide the assembled pumps for a trial fitting.

In one embodiment, the customer places her foot into the assembled pumps. The woman can then identify any areas of the pumps that need adjustment to achieve the desired fit. Any excessive spaces or voids between the customer's foot and the pump are identified, and the internal components can be adjusted or replaced, or additional components can be added to improve the fit. For example, excessive space can be filled with an optional heel wrap, lift, or filler pad. Following this trial fitting process, the final selected components are assembled and secured within the shell to provide the custom-fit pumps.

During the building process or after each pump has been built, the woman's footwear profile can be updated using the identification indicia on the shell, the footbed, heel counter and other internal components of the final assembly so that future footwear assemblies can be easily ordered and assembled for the woman.

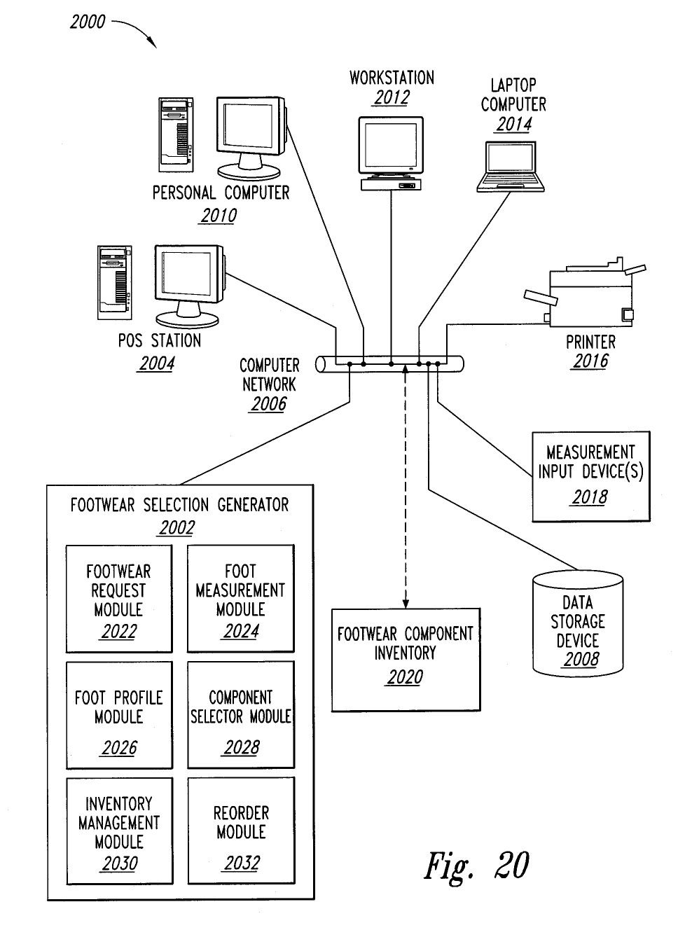

FIG. 20 depicts a system 2000 for customized fitting, building and selling of footwear in accordance with another embodiment of the disclosure. Use of the system 2000 can substantially automate and increase accuracy of a customer-specific footwear custom-fitting process while decreasing cost and increasing the convenience of maintaining and tracking a retail footwear inventory. The system 2000 includes a customer-specific footwear selection generator 2002, which, in one embodiment, can reside on user computer (such as computer 101) at, e.g., a single retail store location. In other embodiments, the footwear selection generator 2002 can reside on a server such as server 308 (FIG. 3, discussed below), in communication with client computers, such as personal computer 2010, workstation 2012, laptop computer 2014, point-of-sale (POS) station 2004, etc. (“client computer”), through a computer network 2006. The computer network 2006 can be substantially similar in structure and function to computer network 206, or in another embodiment, the computer network 2006 can be a private network, such as an intranet. The footwear selection generator 2002 can be in communication with one or more measurement input devices 2018. The footwear selection generator 2002 can also be in communication with a data storage device 2008. The system 2000 can also include a printer 2016, and/or other devices in communication with the footwear selection generator 2002 through the computer network 2006.

In one embodiment, the footwear selection generator 2002 can be associated directly with a provider of multi-component footwear assemblies (described in more detail below), such as a shoe and/or other footwear manufacturer, a footwear retailer, etc. In some embodiments, the footwear selection generator 2002 can be accessible and used by a plurality of footwear retailers. For example, the footwear selection generator 2002 can be in direct communication with the computer network 2006, which can be operatively connected to a plurality of in-store client computers (e.g., personal computer 2010, workstation 2012, laptop computer 2014, POS station 2004, etc.). The footwear selection generator 2002 can also be in direct (or indirect) communication with the plurality of measurement input devices 2018 configured to measure and/or extract customer-specific foot-related information and/or images. In other embodiments, the footwear selection generator 2002 can be accessed and used by a single retailer for generating customer-specific footwear profiles and footwear assembly options. In these embodiments, the footwear selection generator 2002 need not be associated with a footwear manufacturer, but may be associated only with the specific retailer.

In one embodiment, the footwear selection generator 2002 can include a footwear request module 2022, a foot measurement module 2024, a foot profile module 2026, and a component selector module 2028. In other embodiments, the footwear selection generator 2002 can also include one or more additional modules, such as an inventory management module 2030 and a reorder module 2032, all of which will be described in more detail below. The footwear request module 2022 can be included for allowing a customer to initiate a footwear custom-fitting process. The footwear request module 2022 can be configured to receive a request from a client computer to initiate a custom-fitting process and to receive customer-specific information for narrowing footwear selection options from a variety of selection options. In one example, the variety of selection options includes every possible footwear assembly that can be assembled from a footwear component inventory 2020.

Customer-specific information can be generated and input into the client computer using a variety of information retrieval formats. For example, the customer and/or other user of the client computer (e.g., retail clerk, shoe salesman, etc.) can input answers to pre-established questions requesting appropriate information from the customer to assist in the footwear custom-fitting and selection process. Input of answers can be done using a variety of input devices, such as a keyboard, mouse, microphone, touch screen, etc. As described above with respect to the customer questionnaire, requested customer information can include a customer's footwear preferences (gender, category/style, material, color, etc.), anticipated activities, activity level, medical conditions, special needs, etc.

The footwear selection generator 2002 can also include the foot measurement module 2024. The foot measurement module 2024 can be configured to receive data from one or more measurement input devices 2018. As described above, measurement input devices 2018 can include laser and/or light scanning devices for creating a 3-D image of a customer's foot in static or dynamic conditions. In another embodiment, the measurement input devices 2018 can include a pressure sensing device for determining static and dynamic weight distribution on the customer's foot.

Information received by the footwear request module 2022 and the foot measurement module 2024 can be assimilated and processed by the foot profile module 2026 to generate a customer-specific footwear profile. In some embodiments, the footwear profile will include images. In other embodiments, the foot profile module 2026 can be configured to narrow footwear component selection options from the greater number of options provided by the footwear component inventory 2020. Information received by the footwear request module 2022 and the foot measurement module 2024, as well as the customer-specific footwear profile generated by the foot profile module 2026, can be stored on a data storage device, such as the data storage device 2008, configured to store footwear profile and footwear component inventory related data.

The component selector module 2028 can be configured to receive a shell selection from the client computer. In one embodiment, the shell selection options can be narrowed and/or recommended by the foot profile module 2026. Following a trial fitting and preference selection by a customer, the selected shell and shell size can be input into the client computer and received by the component selector module 2028. Upon receiving the shell selection, the component selector module 2028 can narrow internal component selection options based on 1) the shell selection, and 2) the footwear profile generated by the foot profile module 2026. In one embodiment, the component selector module 2028 can be configured to report and deliver a recommended list of possible internal components to be inserted and/or positioned inside the selected shell.

Following delivery of the recommended list of possible internal components, the foot profile module 2026 can be configured to receive from a client computer a final selected list of components used to assemble the footwear assembly. The final list can be stored in the data storage device 2008 as part of the customer-specific footwear profile.

The footwear selection generator 2002 can also include the inventory management module 2030 configured to track quantity and style of individual footwear components in the footwear component inventory 2020. In one embodiment, the inventory management module 2030 can be configured to update inventory information in the data storage device 2008 on a real-time basis. In a specific example, if two footwear assemblies are purchased by a customer, the inventory management module 2030 can, in real-time, debit the number of individual components sold in the assembly from the total number of individual components in the footwear component inventory 2020. Accordingly, a retailer can assess, in real-time, an inventory status for each component.

The inventory management module 2030 can also be configured to track and detect a low threshold level for each individual component. The low threshold level can indicate the need to reorder individual components. In one embodiment, the low threshold level can be a pre-set level that depends on the rate at which the component leaves the inventory 2020. In some embodiments, the individual components can have different threshold levels. For example, a first footbed component may be purchased by customers at a faster rate than a second footbed component. Accordingly, the threshold level of the first footbed component can be set at a higher number than the second footbed component to ensure that the retailer does not run out of the first footbed component.

The footwear selection generator 2002 can also include a reorder module 2032 configured to receive a threshold level warning from the inventory management module 2030 and reorder the individual component from a supplier and/or manufacturer. The reorder module 2032 may prompt a user (e.g., the retailer) to acknowledge and accept a reorder proposal. However, in another embodiment, the reorder module 2032 can be configured to automatically generate and communicate reorder instructions to a supplier and/or manufacturer via the computer network 2006.

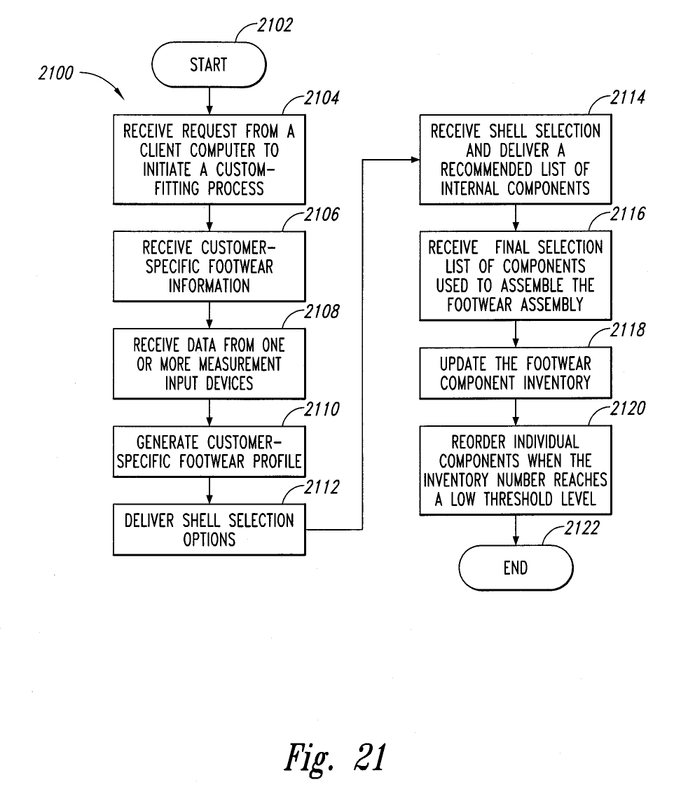

FIG. 21 is a flow diagram of a routine 2100 for customized fitting, building and selling of footwear assemblies in accordance with an embodiment of the disclosure. In one aspect of this embodiment, the routine 2100 can be at least partially performed by a retailer of footwear assemblies. The retailer can perform the routine 2100 with a user and/or client computer (e.g., the user computer 202 of FIG. 2). In other embodiments, the routine 2100 can be performed by other entities using other networked and non-networked devices for customized fitting, building and selling of footwear assemblies.

The routine 2100 begins 2102 and a request is received from a client computer to initiate a custom-fitting process (block 2104). The footwear request module 2022 receives customer-specific footwear information from the customer via input into the client computer (block 2106) The foot measurement module 2024 receives data from one or more measurement input devices 2018 (block 2108). Following receiving information in blocks 2106 and 2108, the foot profile module 2026 generates a customer-specific footwear profile at least partially based on the footwear information and the data (block 2110). The routine 2100 can include delivering shell selection options to the client computer (block 2112), wherein the shell selection options are determined by the footwear profile generated in block 2110. The routine 2100 can further include receiving a shell selection and delivering a recommended list of internal components (block 2114). In one embodiment, the recommended list can be determined by the shell selection received and the footwear profile.

The routine 2100 can further include providing to the foot profile module 2026 a final selection list of components used to assemble the footwear assembly (block 2116). In one embodiment, the footwear profile with the final selection list can be stored in the data storage device 2008 for future reference. The inventory management module can update the footwear component inventory 2020 upon removal or delivery of individual components from or to the inventory (block 2118). In some embodiments, the routine 2100 can include reordering individual components when the number of the individual component reaches a low threshold level in the footwear component inventory 2020 (block 2120). The routine 2100 can end 2122 following any one of steps in blocks 2114, 2116, 2118 and 2120.

As indicated above, embodiments of the system may include a computer system that provides a computing environment to help operate aspects of the system. FIG. 2 and the following discussion provide a brief, general description of a suitable computing environment in which aspects of the system can be implemented. Although not required, some aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, hand-held devices, wearable computers, cellular or mobile devices, multi-processor systems, microprocessor-based or programmable consumer electronics, set-top boxes, network PCs, mini-computers, mainframe computers and the like. The disclosure can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the disclosure may reside on a server computer, while corresponding portions reside on a client computer. Data structures and transmission of data particular to aspects of the disclosure are also encompassed within the scope of the disclosure.

Referring to FIG. 2, one embodiment of the disclosure employs a computer system 200, such as a personal computer or workstation, having one or more processors 206 coupled to one or more user input devices 214 and data storage devices 240. The computer is also coupled to at least one output device 220, such as a display device and one or more optional additional output devices 208 (e.g., printer, plotter, speakers, tactile or olfactory output devices, etc.). The computer may be coupled to external computers, such as via an optional network connection 250, a wireless transceiver 260, or both.

The input devices 220 may include a keyboard, touch screen, microphones, mouse or other pointing device. Other input devices are possible such as a joystick, pen, game pad, scanner, digital camera, video camera, imaging device, and the like. The data storage devices 240 may include any type of computer-readable media that can store data accessible by the computer processors 206, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

Aspects of the disclosure may be practiced in a variety of other computing environments. For example, referring to FIG. 3, a distributed computing environment with a web interface includes one or more user computers 302 in a system 300 are shown, each of which includes a browser program module 304 that permits the computer to access and exchange data with the Internet 306, including web sites within the World Wide Web portion of the Internet. The user computers may be substantially similar to the computer described above with respect to FIG. 2. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 308, coupled to the Internet or World Wide Web (“Web”) 306, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 310 or databases, coupled to the server computer(s), stores much of the web pages and content exchanged between the user computers. The server computer(s), including the database(s), may employ security measures to inhibit malicious attacks on the system and to preserve integrity of the messages and data stored therein (e.g., firewall systems, secure socket layers (SSL), password protection schemes, encryption, and the like).

The server computer 308 may include a server engine 312, a web page management component 314, a content management component 316 and a database management component 318. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as video, graphics and audio signals.

Many of the functional units described herein have been labeled as modules, in order to more particularly emphasize their implementation independence. For example, modules may be implemented in software for execution by various types of processors, such as processor 106. An identified module of executable code may, for instance, comprise one or more physical or logical blocks of computer instructions which may, for instance, be organized as an object, procedure, or function. The identified blocks of computer instructions need not be physically located together, but may comprise disparate instructions stored in different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The systems and methods for retail selling and manufacturing custom-fit footwear assemblies disclosed herein enables the provider of footwear to assemble a custom-fit footwear assembly that is fashionable, comfortable, and supportive. The customer is more satisfied because each footwear assembly is individually custom-fit which results in greater satisfaction and fewer product returns. Because the footwear internal components are interchangeable, a retailer's inventory may be reduced. Additionally, because the individual footwear internal components each include identification indicia, ordering and building new custom-fit footwear assemblies is simplified for the customer and retailer. Furthermore, reordering and managing the inventory can also be streamlined and made efficient. Moreover, the shells can also accommodate pre-fabricated orthotics, making prescription footwear affordable and accessible to more customers.

In general, the detailed description of embodiments of the disclosure is not intended to be exhaustive or to limit the disclosure to the precise form disclosed above. While specific embodiments of, and examples for, the disclosure are described above for illustrative purposes, various equivalent modifications are possible within the scope of the disclosure, as those skilled in the relevant art will recognize. The teachings of the disclosure provided herein can be applied to other systems, not necessarily the system described herein. The elements and acts of the various embodiments described herein can be combined to provide further embodiments.

These and other changes can be made to the disclosure in light of the above Detailed Description. While the above description details certain embodiments of the disclosure and describes the best mode contemplated, no matter how detailed the above appears in text, the disclosure can be practiced in many ways. Details of the disclosure may vary considerably in its implementation details, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following examples should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure.

I claim:

1. A system for customized fitting and building footwear assemblies at a retail outlet, comprising:
a foot measuring device for obtaining three dimensional measurement data of a person's foot at the retail outlet;
an inventory of footwear components that can be selected and assembled at the retail location to build a footwear assembly, wherein inventory of footwear components include:
a first inventory portion containing footwear shells having a plurality of sizes and styles, and wherein a customer can select a shell style for the footwear assembly;
a second inventory portion containing footbeds having a plurality of sizes, each footbed being configured to fit into at least a plurality of the footwear shells in the first inventory portion;
a third inventory portion containing heel counters having a plurality of sizes, each heel counter being configured to fit into at least a plurality of the footwear shells from the first inventory portion and being usable with at least a plurality of footbeds from the second inventory portion;
a fourth inventory portion containing a plurality of fillers, each filler being configured to fit into at least a plurality of the footwear shells from the first inventory portion and being usable with at least a plurality of footbeds from the second inventory portion; and
a computer system configured to receive and use the measurement data and a data about the selected shell style and to automatically select a footwear shell of the selected shell style and at least one of a footbed, heel counter, and a filler that can be assembled with the footwear shell at the retail outlet to form a footwear assembly custom fit for the person's foot.

2. The system of claim 1 wherein the footwear shells in the first inventory portion each having an outer sole and an upper connected to the outer sole, and wherein the footwear shells include shell styles in the category of at least one of men's footwear, women's footwear, and children's footwear.

3. The system of claim 1 wherein at least a plurality of the heel counters are fixedly attachable to a footbed before the footbed is inserted into the footwear shell.

4. The system of claim 1 wherein the fillers in the fourth inventory portion include plurality of at least one of lifts, toe box pads, forefoot pad, forefoot wrap, and heel pads insertable into the footwear shells.

5. The system of claim 1 wherein a plurality of the internal components are removable, replaceable and interchangeable in a plurality of footwear shells.

6. The system of claim 1 wherein at least a plurality of footwear shells in the first inventory portion include a rear heel flap configured to fold over and retain the heel counter in the footwear shell.

7. The system of claim 1 wherein the second inventory portion includes a plurality of footbeds that vary in length and internal width for accommodating feet with variable widths.

8. The system of claim 1 wherein the third inventory portion includes a plurality of heel counters that vary in internal width to accommodate feet with variable heel widths.

9. The system of claim 1, further comprising a questionnaire configured for collecting information from a customer about at least one of customer gender, activity level, footwear style preference, and special footwear needs.

10. The system of claim 1 wherein the foot measuring device includes a scanning device for creating a simulated three-dimensional model of the person's foot.

11. The system of claim 1 wherein the foot measuring device is configured to collect foot measurement data during static and dynamic conditions of the foot.

12. The system of claim 1 wherein each of the footwear shells, the footbeds, and the heel counters include trackable inventory identification configured for use in monitoring component inventory levels in the first, second, and third inventory portions.

13. A method for custom-fitting and building a footwear assembly in a retail outlet, the method comprising:
providing an inventory of footwear components at the retail outlet, the inventory including:
a first inventory portion containing footwear shells having a plurality of sizes and styles;
a second inventory portion containing footbeds having a plurality of sizes, each footbed being configured to fit into at least a plurality of the footwear shells in the first inventory portion; and
a third inventory portion containing heel counters having a plurality of sizes, each heel counter being configured to fit into at least a plurality of the footwear shells from the first inventory portion and being usable with at least a plurality of footbeds from the second inventory portion;
collecting three-dimensional measurement data about a foot of a customer at the retail outlet;
generating a customer-specific footwear profile using at least a portion of the measurement data;
identifying a selected style of the footwear shell;
calculating a component selection from the measurement data, the selected style profile, and data related to the components in the inventory, wherein the component selection includes a selection of a footwear shell of the selected style, a footbed, and a heel counter to provide a custom fit the foot of the customer; and
assembling the selected of a footwear shell of the selected style, the footbed, and the heel counter at the retail outlet to build a custom-built footwear.

14. The method of claim 13, further comprising fitting the custom-built footwear to the foot of the customer, and adjusting internal components within the footwear shell to adjust the fit of the custom-built footwear relative to the foot.

15. The method of claim 13, further comprising collecting footwear profile data from the customer, wherein the footwear profile data includes data relating to at least one of the customer's gender, age, activity level, special footwear needs, and style preference.

16. The method of claim 15, wherein calculating the component selection includes using data from the footwear profile data.

17. A system for building and selling of customized footwear to a customer at a retail location, comprising:
a server;
a client computer at the retail location;
a computer network connected to the server and the client computer for transmitting footwear assembly requests and data, footwear profile information, and inventory reorder requests; and
a footwear selection generator comprising,
a footwear request module configured to receive a request from the client computer to initiate a footwear custom-fitting process;
a foot measurement module configured to receive foot measurement data from a measurement input device;
a foot profile module configured to generate a customer-specific footwear profile, wherein the footwear profile includes foot related information and recommendations for selection options of footwear assembly components; and
a component selector module configured to receive a shell selection from the client computer and report a recommended list of possible internal components to be inserted in a selected shell based on at least the a) shell selection, and the b) footwear profile.

18. The system of claim 17 wherein the footwear request module is further configured to receive customer-specific information for narrowing footwear selection options from a variety of selection options.

19. The system of claim 17 wherein the measurement input device includes a scanning device for creating a three-dimensional image of a foot.

20. The system of claim 17 wherein the footwear selection generator further comprises:
an inventory management module configured to track a quantity of an individual footwear component in a footwear component inventory; and
a reorder module configured to receive a threshold level warning from the inventory management module indicating a low quantity of the individual footwear component in the footwear component inventory and reorder the individual footwear component for which the threshold level warning was received.

21. The system of claim 17, further comprising a database for storing footwear profile data.

22. A computer-implemented method for custom-fitting and building a footwear assembly at a retail outlet, the method comprising:
receiving at a retail outlet a request to initiate a custom-fitting process;
receiving customer-specific footwear information from a customer at the retail outlet;
receiving data from a measurement input device;
generating a customer-specific footwear profile based on the footwear information and the data;
delivering shell selection options at least partially determined by the footwear profile; and
receiving a shell selection and delivering at the retail outlet a recommended list of internal components, wherein the recommend list is at least partially determined by the shell selection and the footwear profile.

23. The method of claim 22, further comprising:
receiving a list of footwear components assembled into the footwear assembly; and
updating a footwear component inventory by reducing an inventory quantity based on the list of footwear components.

24. A computer-readable medium whose contents cause at least one computer to perform a method for custom-fitting and building a footwear assembly, the method comprising:
receiving a request to initiate a custom-fitting process;
receiving customer-specific footwear information from a customer;
receiving data from a measurement input device;
generating a customer-specific footwear profile based on the footwear information and the data;
delivering shell selection options at least partially determined by the footwear profile; and
receiving a shell selection and delivering a recommended list of internal components, wherein the recommend list is at least partially determined by the shell selection and the footwear profile.

25. A system for customized fitting and building footwear assemblies at a retail outlet, comprising:
a foot measuring device for obtaining three dimensional measurement data of a person's foot at the retail outlet; and
an inventory of footwear components that can be selected and assembled at the retail location to build a footwear assembly, wherein inventory of footwear components include:
a first inventory portion containing footwear shells having a plurality of sizes and styles, and wherein a customer can select a shell style for the footwear assembly;
a second inventory portion containing heel counters having a plurality of sizes, each heel counter being configured to fit into at least a plurality of the footwear shells from the first inventory portion; and
a computer system configured to receive and use the measurement data and a data about the selected shell style and to automatically select a footwear shell of the selected shell style and at least one of a footbed, heel counter, and a filler that can be assembled with the footwear shell at the retail outlet to form a footwear assembly custom fit for the person's foot.

26. The system of claim 25, further comprising a third inventory portion containing footbeds having a plurality of sizes, each footbed being configured to fit into at least a plurality of the footwear shells in the first inventory portion and being usable with at least a plurality of heel counters from the second inventory portion.

27. The system of claim 25, further comprising a third inventory portion containing a plurality of fillers, each filler being configured to fit into at least a plurality of the footwear shells from the first inventory portion.

28. The system of claim 25, wherein each of the footwear shells contain a footbed therein.
